(19) United States
(12) Patent Application Publication
(10) Pub. No.: US 2014/0023232 A1
(43) Pub. Date: Jan. 23, 2014

(54) METHOD OF DETECTING TARGET IN IMAGE AND IMAGE PROCESSING DEVICE

(71) Applicant: SAMSUNG ELECTRONICS CO., LTD., SUWON-SI (KR)

(72) Inventors: IRINA KIM, Suwon-si (KR); EVGENY ARTYOMOV, Ramat-Gan (IL); GERMAN VORONOV, Ramat-Gan (IL); OR SHIMSHI, Ramat-Gan (IL)

(21) Appl. No.: 13/945,540

(22) Filed: Jul. 18, 2013

(30) Foreign Application Priority Data
Jul. 18, 2012 (KR) 10-2012-0078317

(51) Int. Cl. G06K 9/00

(52) U.S. Cl. CPC G06K 9/00624
USPC 382/103; 382/225; 382/240

(57) ABSTRACT

A method of detecting a target in an image. The method includes receiving an image; generating a plurality of scaled-down images based on the received image; generating integral column images of each of the plurality of scaled images by calculating integral values of pixels column by column; selecting and classifying a plurality of windows of the integral column images according to a feature arithmetic operation based on a recursive column calculation; and detecting the target on the basis of the classification results for the plurality of windows.

### CROSS-REFERENCE TO RELATED APPLICATIONS

This U.S. non-provisional patent application claims priority under 35 U.S.C. §119 of Korean Patent Application No. 10-2012-0078317, filed on Jul. 18, 2012, the entire contents of which are hereby incorporated by reference.

1. Technical Field

The present inventive concept herein relates to a method of detecting a target in an image and an image processing device.

2. Discussion of the Related Art

Consumer demand for mobile imaging equipment such as a smart phone, a smart pad, a notebook computer, etc. increases rapidly. Various devices for generating and displaying multimedia contents are being introduced to the portable information equipment.

A camera is device typically used to generate multimedia content. A camera implemented as a digital still camera or a digital (video) camcorder obtains images and also may function as multipurpose equipment such as a smart phone and a tablet or smart pad.

In a portable information equipment such as a smart-phone/camera, various functions for increasing convenience of users are being developed. One of the convenient functions is target detection function for detecting a target in an image obtained using the camera. The target detecting function may be used to detect a person in the scene captured in the image and may be used as basis information for analyzing feelings and pose of a person in an image. The target detecting function detects the location of the target in an image and can be used as information for controlling a shooting direction, rate, and/or the optical focus distance of camera.

### SUMMARY

Exemplary embodiments of the inventive concept provide a method of detecting a target in an image. The method includes receiving an image; generating a plurality of scaled images on the basis of the received image; generating integral column images of the plurality of scaled images by calculating integral values of pixels column by column; classifying windows in the plurality of scaled images using the integral column images according to a feature arithmetic operation based on a recursive column calculation; and detecting the target on the basis of the windows classification results.

Exemplary embodiments of the inventive concept also provide an image processing device. The image processing device includes an image pyramid generating unit receiving an image and generating an image pyramid on the basis of the received image; a downscaling unit receiving the image pyramid and down-scaling each image of the image pyramid to output a plurality of images including the image pyramid and the downscaled image; a prefiltering unit outputting part of the plurality of the images on the basis of color maps of the plurality of images; an integral column generating unit receiving the part of the plurality of the images and performing an integral of each of the part of the plurality of the images by column unit to generate integral column images; a plurality of recursive column classifying units receiving the integral column images and classifying windows in the integral column images with respect to the received integral column image according to a feature arithmetic operation based on a recursive column calculation; and a clustering and tracking unit detecting a target in the image according to the windows classification result.

Embodiments of inventive concepts will be described more fully hereinafter with reference to the accompanying drawings, in which exemplary embodiments of the inventive concept are shown. This inventive concept may, however, be embodied in many different forms and should not be construed as limited to the exemplary embodiments set forth herein. Rather, these exemplary embodiments are provided so that this disclosure will be thorough and complete, and will fully convey the scope of the inventive concept to those skilled in the art. In the drawings, the size and relative sizes of layers and regions may be exaggerated for clarity. The embodiments of the inventive concept may, however, be embodied in different forms and should not be constructed as limited to the exemplary embodiments set forth herein. Rather, these exemplary embodiments are provided so that this disclosure will be thorough and complete, and will fully convey the scope of the inventive concept to those skilled in the art. Like numbers refer to like elements throughout.

### BRIEF DESCRIPTION OF THE FIGURES

Preferred embodiments of the inventive concept will be described below in more detail with reference to the accompanying drawings, in which:

FIG. 1 is a flow chart illustrating a method of detecting a target in an image in accordance with some exemplary embodiments of the inventive concept;

FIG. 2 is a block diagram of a first example of image processing device performing the method of FIG. 1;

FIG. 3 is a drawing illustrating an operation of image pyramid generating unit of FIG. 2;

FIG. 4 is a drawing illustrating an operation that a caching unit stores an image pyramid;

FIGS. 5A and 5B are drawings illustrating a method that a downscaling unit of FIG. 2 scales down each image stored in a caching unit;

FIG. 6 is a drawing illustrating a method that an integral column generating unit of FIG. 2 generates an integral column image;

FIG. 7 is a drawing illustrating an operation of one among recursive column classifying units of FIG. 2;

FIG. 8 is a drawing illustrating an example that the recursive column classifying units of FIG. 2 operate in a cascade form;

FIG. 9 is a flow chart illustrating a method of classifying an integral column image in accordance with some exemplary embodiments of the inventive concept;

FIG. 10 is a drawing illustrating various types of features that can be applied to the image processing device of FIG. 2 and the method of detecting a target in accordance with some exemplary embodiments of the inventive concept;

FIG. 11 is a block diagram illustrating a second example of image processing device performing the method of FIG. 1;

FIG. 12 is a block diagram illustrating a system-on-chip, and an external memory and an external chip that communicate with the system-on-chip in accordance with some exemplary embodiments of the inventive concept; and

FIG. 13 is a block diagram illustrating a multimedia device in accordance with some exemplary embodiments of the inventive concept.

### DETAILED DESCRIPTION OF THE EMBODIMENTS

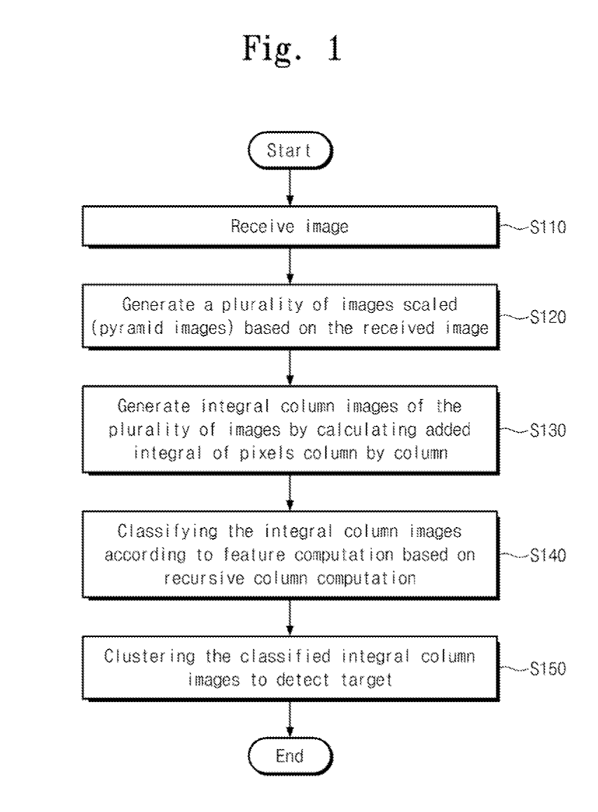

FIG. 1 is a flow chart illustrating a method of detecting a target in an image in accordance with some exemplary embodiments of the inventive concept.

Referring to FIG. 1, in step S110, an image is received. In step S120, a plurality of images (pyramid images) scaled based on the received image is generated. For example, an original image and a plurality of images in which the original image is downscaled may be generated. A plurality of images having different sizes is referred to as an ‘image pyramid’.

In step S130, integral column images of the plurality of images are generated respectively by calculating the added integral of pixels by column unit.

In step S140, integral column images are classified according to a feature arithmetic operation based on a recursive column arithmetic operation.

In step S150, the classified integral column images clusters to detect a target.

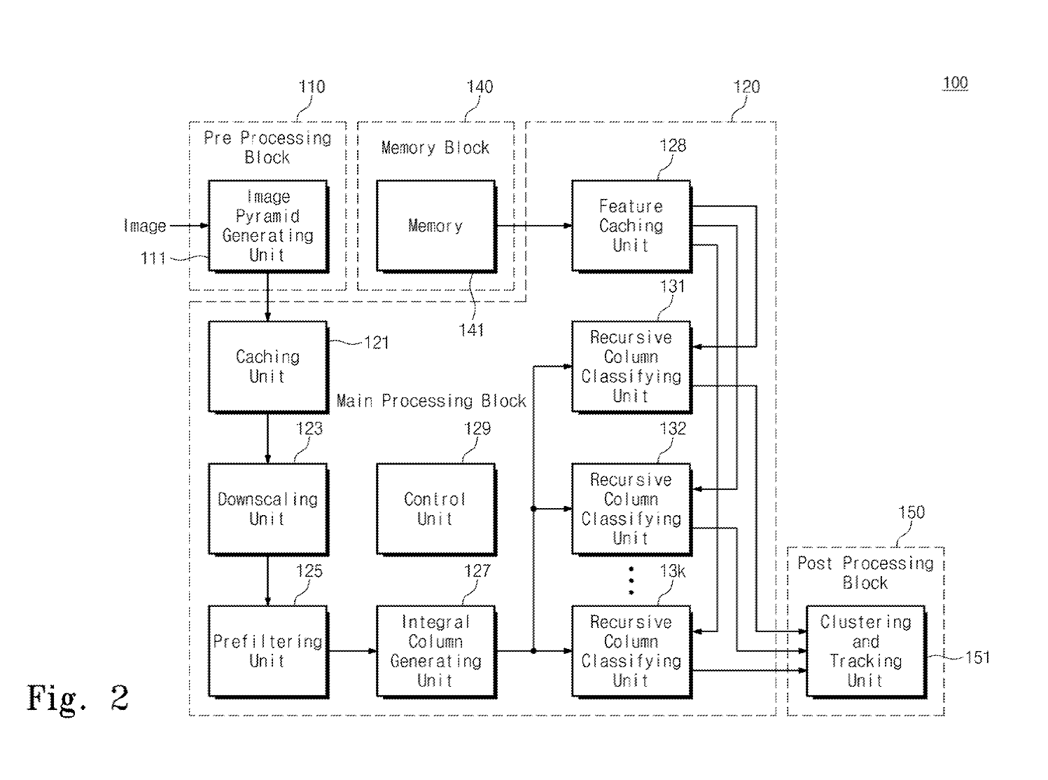

FIG. 2 is a block diagram of a first example of an image processing device 100 performing the method of FIG. 1. Referring to FIGS. 1 and 2, the image processing device 100 includes a preprocessing block 110, a main processing block 120, a memory block 140 and a post processing block 150.

The preprocessing block 110 includes an image pyramid generating unit 111. The image pyramid generating unit 111 receives an image from the outside and generates an image pyramid on the basis of the received image. The image pyramid generating unit 111 generates images sequentially downscaled according to a previously set ratio and a previously set number. The image pyramid generating unit 111 generates images sequentially downscaled according to the ratio and the number set by a user.

The image pyramid generating unit 111 generates a first image having a size 1/n times as large as the received image size and a second image having a size 1/n times as large as the first image size. The image pyramid generating unit 111 generates the previously set number of downscaled images. The image pyramid generating unit 111 can output images including an original image and downscaled images.

The image pyramid generating unit 111 generates downscaled images but it is not limited thereto. The image pyramid generating unit 111 can generate an up-scaled image or an image to be up-scaled, and a downscaled image.

The image pyramid generating unit 111 generates all images according to the previously set ratio but it is not limited thereto. The image pyramid generating unit 111 can generate an image pyramid according to two or more ratios.

The image pyramid generating unit 111 can further generate a color map.

The image pyramid generating unit 111 can generate a color map of the original image or color maps of the original image and the downscaled images to output those color maps.

The main processing block 120 includes a caching unit 121, a downscaling unit 123, a prefiltering unit 125, an integral column generating unit 127, a feature caching unit 128, a control unit 129 and a plurality of recursive column classifying units 131 through 13k.

The caching unit 121 receives an image pyramid being output from the image pyramid generating unit 111 and stores the image pyramid. The caching unit 121 stores each image of the image pyramid by strip unit and can output the stored image by column unit.

The downscaling unit 123 receives an image from the caching unit 121 by column unit and generates intermediate images by column unit. The downscaling unit 123 generates images having a intermediate size of images generated by the image pyramid generating unit 111. The function of the downscaling unit 123 cooperates with that of the image pyramid generating unit 111.

The image pyramid generating unit 111, the caching unit 121 and the downscaling unit 123 perform the step S120 of FIG. 1 to generate a plurality of scaled images.

When the image pyramid generating unit 111 generate s color maps of the original image and the downscaled images, the downscaling unit 123 can scale the color maps to generate scaled color maps.

The prefiltering unit 125 can receive a plurality of scaled maps and scaled color maps from the downscaling unit 123. On the basis of the color maps, the prefiltering unit 125 can reject parts of the plurality of scaled images. The prefiltering unit 125 can reject parts of the scaled images on the basis of color and color change of the color maps. When a target to be detected is a person, the prefiltering unit 125 can reject images corresponding to color maps not having skin color. The prefiltering unit 125 outputs filtered images.

The integral column generating unit 127 receives filtered images from the prefiltering unit 125. The integral column generating unit 127 performs integral of pixel values of each image received by column unit to calculate integral values and can generate an integral column image having calculated integral values.

The feature caching unit 128 can store a plurality of features and transmits the stored features to the plurality of recursive column classifying units 131 through 13k. The feature caching unit 128 can transmit different features to the plurality of recursive column classifying units 131 through 13k.

The control unit 129 controls the overall operation of the main processing unit 120. The control unit 129 controls the prefiltering unit 125 so as to control a filtering object according to a detection target. The control unit 129 controls the feature caching unit 128 so that features are selected according to the detection target and the selected features are stored.

The control unit 129 controls the plurality of recursive column classifying units 131 through 13k so that a window is selected in the integral column image and a classifying operation is performed on the selected window. The control unit 129 controls the plurality of recursive column classifying units 131 through 13k so that features are selected on the basis of an adaptive boosting.

The plurality of recursive column classifying units 131 through 13k sequentially receive the integral column image from the integral column generating unit 127. Each of the plurality of recursive column classifying units 131 through 13k perform a feature arithmetic operation on the basis of the selected window of the integral column image. If the result of the feature arithmetic operation is FALSE, the corresponding window may be rejected. If the result of the feature arithmetic operation is TRUE, a next recursive column classifying unit performs a feature arithmetic operation on the basis of the selected window. The plurality of recursive column classifying units 131 through 13k can have different features.

The first recursive column classifying unit 131 performs a feature arithmetic operation on the basis of the selected window_{—} If the result of the feature arithmetic operation is FALSE, the corresponding integral window may be rejected. If the result of the feature arithmetic operation is TRUE, a feature arithmetic operation can be performed on the basis of the window in which the second recursive column classifying unit 132 is selected.

The window that is determined as TRUE in all the plurality of recursive column classifying units 131 through 13k is transmitted to the post processor 150.

If a classification of the plurality of recursive column classifying units 131 through 13k with respect to the selected window is completed, a window is selected at a different location of the integral column image and a classification may be performed on the selected window.

If a classification is performed on all the integral column images, a classification of integral column image having a different size may be performed.

The plurality of recursive column classifying units 131 through 13k can operate in parallel. The plurality of recursive column classifying units 131 through 13k can receive an integral column image from the integral column generating unit 127 at the same time. The plurality of recursive column classifying units 131 through 13k can receive the same integral column image. The plurality of recursive column classifying units 131 through 13k can perform a feature arithmetic operation on the received integral column image. The feature arithmetic operations of the plurality of recursive column classifying units 131 through 13k can be performed at the same time.

If the feature arithmetic operations of the plurality of recursive column classifying units 131 through 13k are performed in cascade form, the size and complexity of the image processing device 100 may be reduced. One recursive column classifying unit is provided to the image processing device 100, different features are sequentially loaded on one recursive column classifying unit and a recursive feature arithmetic operation may be performed.

If the feature arithmetic operations of the plurality of recursive column classifying units 131 through 13k are performed at the same time, operation performance of the image processing device 100 may be improved. If the plurality of recursive column classifying units 131 through 13k performs a feature arithmetic operation at the same time, the speed that the image processing device 100 performs a feature arithmetic operation on a specific window increases.

The memory block 140 includes a memory 141. The memory 141 may include a random access memory (RAM). The memory 141 may include a volatile memory such as a static RAM (SRAM), a dynamic RAM (DRAM), a synchronous DRAM (SDRAM), etc. or a nonvolatile memory such as an electrically erasable and programmable ROM (EEPROM), a flash memory, a phase-change RAM (PRAM), a magnetic RAM (MRAM), a resistive RAM (RRAM), a ferroelectric RAM (FRAM), etc. The memory 141 may include a wideband I/O memory.

The memory 141 stores a plurality of features and can transmit the stored features to the feature caching unit 128. The memory 141 can transmit the selected features among the stored features to the feature caching unit 128 according to the control of the control unit 129.

The post processing block 150 includes a clustering and tracking unit 151. The clustering and tracking unit 151 collects windows determined as TRUE by the plurality of recursive column classifying units 131 through 13k and combines the windows to select or set the optimum window. The clustering and tracking unit 151 can track a target on the basis of the selected or set window. The clustering and tracking unit 151 can track a look, pose, feelings of the target on the basis of the tracked target.

The image processing device 100 can form a system-on-chip (SoC). Each constituent element of the image processing device 100 may be constituted by hardware of the system-on-chip (SoC), or may be formed by software being executed in the hardware or by a combination of the software and the hardware.

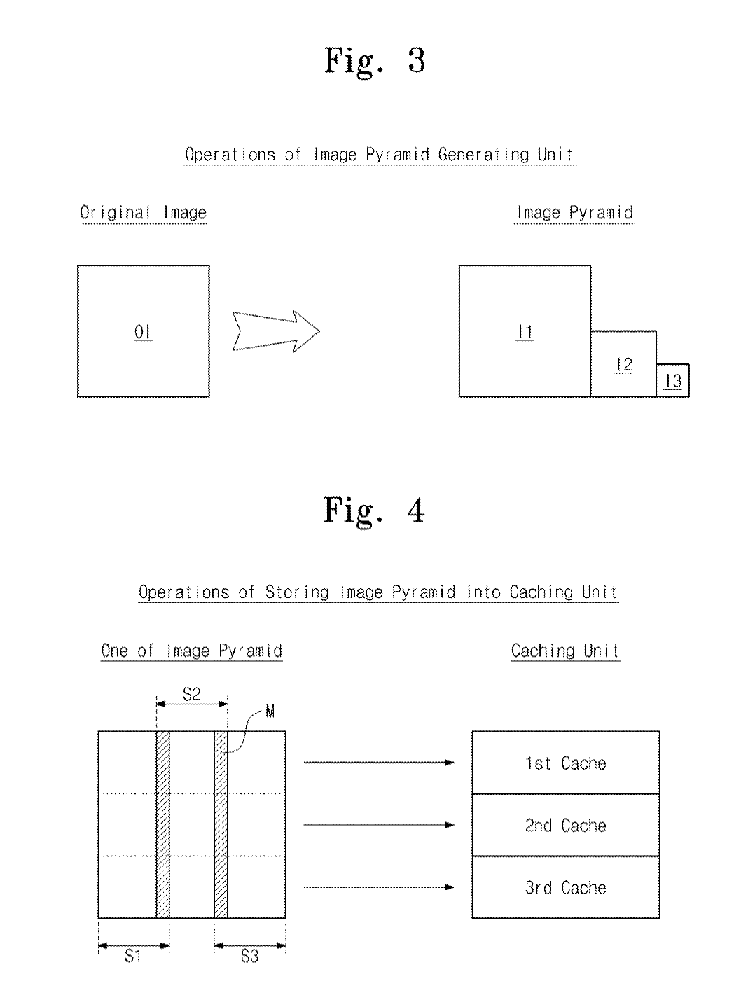

FIG. 3 is a drawing illustrating the operation of image pyramid generating unit of FIG. 2. Referring to FIGS. 2 and 3, the image pyramid generating unit 111 receives an original image OI and generates a plurality of images I1˜13 in which the original image 10 is scaled. The plurality of images I1˜13 may include the original image OI. The plurality of images I1˜13 may include the original image OI and images in which the original image OI is downscaled. The generated images may be called an image pyramid.

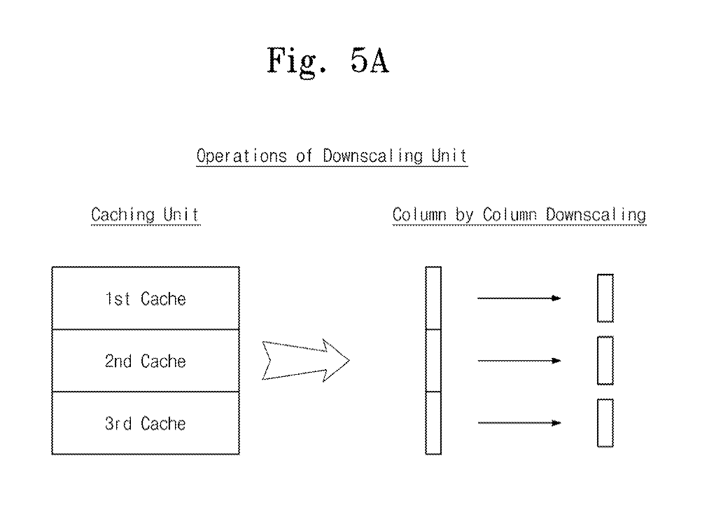

FIG. 4 is a drawing illustrating the operation that a caching unit 121 stores an image pyramid. Referring to FIGS. 2 and 4, each image of the image pyramid is divided into a plurality of strips S1˜S3. The strips S1˜S3 may have an overlapped margin (M) between each adjacent pair.

Each strip is divided into a plurality of parts according to its height. Each part divided according to its height is stored in a plurality of caches of the caching unit 121.

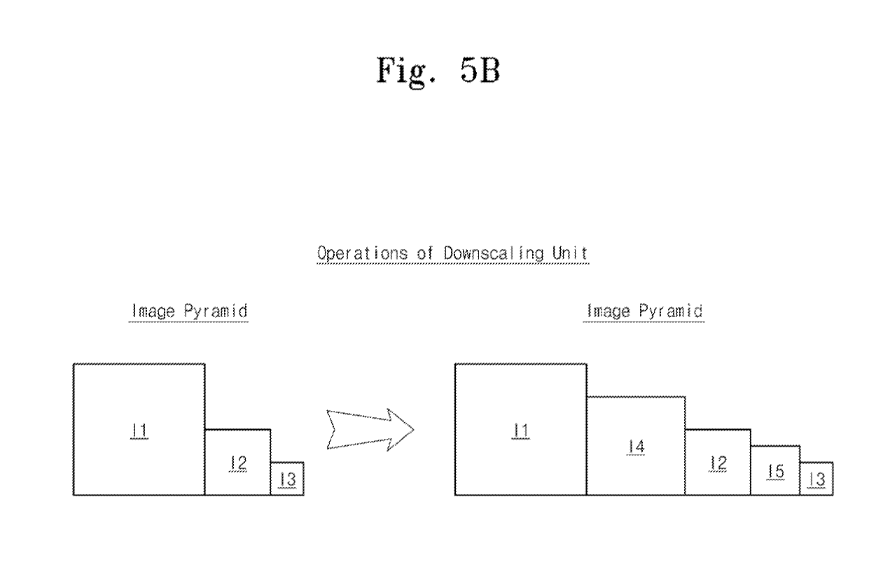

FIGS. 5A and 5B are drawings illustrating a method that the downscaling unit 123 of FIG. 2 scales down each image stored in the caching unit 121. Referring to FIGS. 2 and 5A, an image stored in caches is output by column unit. The downscaling unit 123 downscales the image by column unit. The downscaling unit 123 downscales columns being output from caches according to the predetermined ratio.

Referring to FIGS. 2 and 5B, the pyramid images I1˜13 are scaled down to a plurality of images. I1˜15 by the downscaling unit 123. Additional scaled images 14 and 15 are generated from the pyramid images I1, I2 and I3.

Thus, a plurality of scaled images including the original image is generated by the image pyramid generating unit 111, the caching unit 121 and the downscaling unit 123.

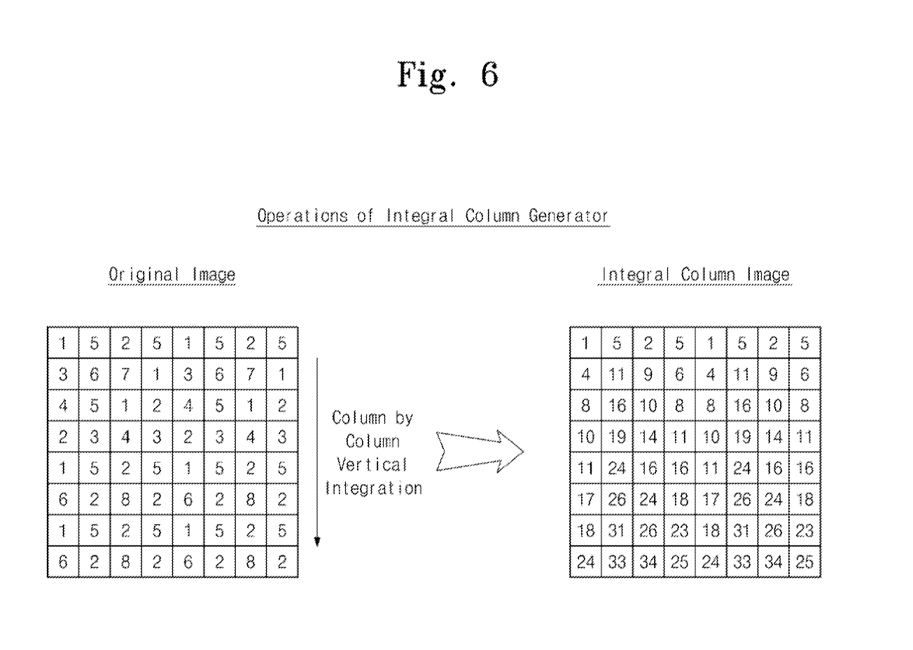

FIG. 6 is a drawing illustrating a method that the integral column generating unit 127 of FIG. 2 generates an integral column image. Referring to FIGS. 2 and 6, the integral column generating unit 127 can generate an integral column image by column unit (of each column) of each image. The integral column generating unit 127 calculates integral values by performing an integration of pixel values along a specific direction (e.g., vertically down as shown in FIG. 6). The integral column generating unit 127 generates an integral column image having integral values at the locations of pixels of each column.

The integral column generating unit 127 performs an integration of gray scale values of pixels to generate an integral column image.

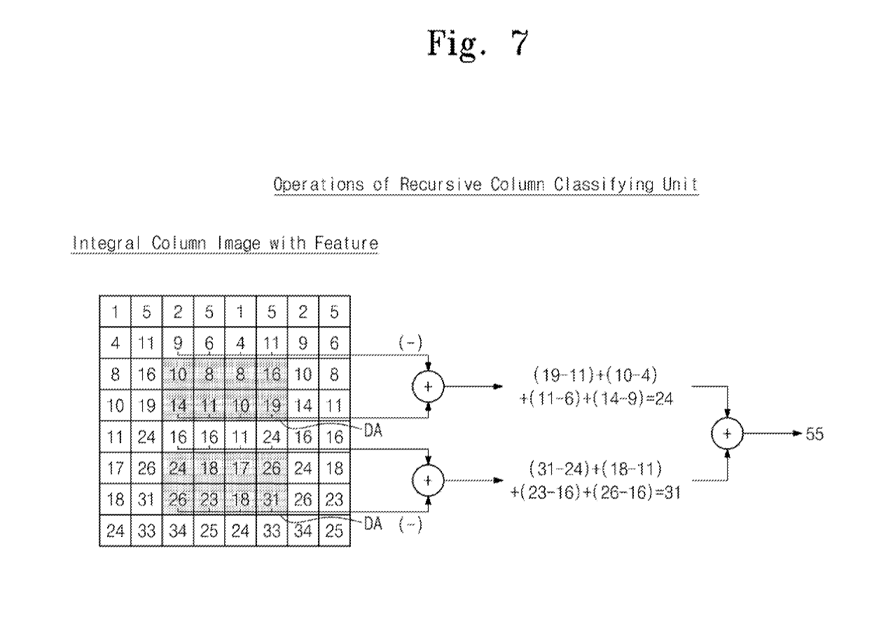

FIG. 7 is a drawing illustrating the operation of one recursive column classifying unit among the recursive column classifying units 131 through 13k of FIG. 2. Referring to FIGS. 2 and 7, a window is selected from an integral column image. A classifying operation is performed in the selected window. For brevity of description, it is assumed that the whole integral column image illustrated in FIG. 6 is selected as a window. However, the window may be selected as not the whole integral column image but rather consisting of a part of the integral column image.

The recursive column classifying unit performs a feature arithmetic operation. The selected window includes a selected area and an unselected area. The selected area may be a feature. The feature arithmetic operation may be the arithmetic operation of finding the sum of pixel values of the selected area. The recursive column classifying unit can more easily perform the feature arithmetic operation with the data of the integral column image than when using a conventional image.

In FIG. 7, a dotted area (DA) (appearing gray in FIG. 7) may be a feature. The feature may include a plurality of areas (e.g., an upper gray area and a lower gray area as shown).

The recursive column classifying unit performs a feature arithmetic operation by column unit of an integral column image. The recursive column classifying unit adds integral values of the lowermost row of each area of the feature in each column and can subtract integral values of the row just above the uppermost row of each area. The calculation result is the sum of pixel values corresponding to the feature.

The recursive column classifying unit, according to the feature type, collects the specific number of integral values of each column of an integral column image to perform a feature arithmetic operation. As illustrated in FIG. 7, when the feature includes two areas distributed vertically, the recursive column classifying unit collects four integral values from each column.

In a column in which a feature does not exist, the recursive column classifying unit can collect and arithmetically operate the same integral value four times. Thus, in a column in which a feature does not exist, an arithmetic operation result is 0.

In a column in which a feature exists, the recursive column classifying unit can collect and calculate an integral value in a row just above each area of the feature and an integral value of the lowermost row of each area of the feature.

The recursive column classifying unit compares a calculation result with a reference range. If the calculation result is within the reference range, the classifying result of the selected window is determined as TRUE. If the calculation result is not within the reference range, a classifying result of the selected window may is determined as FALSE.

If the classifying result is determined as FALSE, the corresponding window may be rejected. Thus, that classification with respect to the corresponding window may be complete.

If the classifying result is determined as TRUE, a next step of classification with respect to the corresponding window is performed. Thus, another recursive column classifying unit may perform a classification using another feature.

The image processing device 100 selects features on the basis of an adaptive boosting.

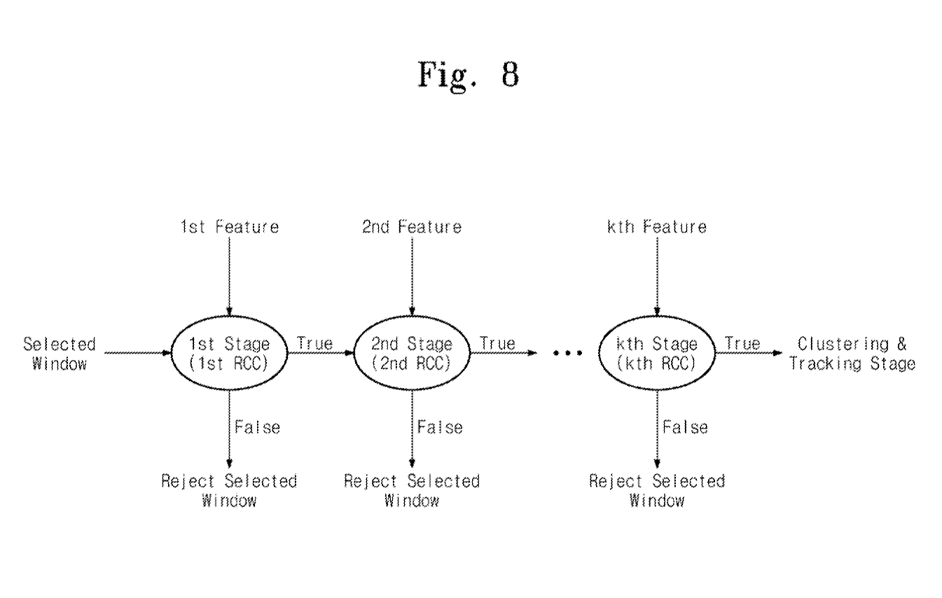

FIG. 8 is a drawing illustrating an example that the recursive column classifying units 131 through 13k of FIG. 2 operate in a cascade manner. Referring to FIGS. 2, 7 and 8, the first recursive column classifying unit 131 forms a first stage. A classification of the first stage is performed using a first feature. The classification of the first stage is performed by the first recursive column classifying unit 131. If a classification of the first stage is determined as FALSE, the selected window is rejected. If a classification of the first stage is determined as TRUE, a classification of a second stage is performed. The classification of the second stage is performed by the second recursive column classifying unit 132. The classification of the second stage may be performed using a second feature different from the first feature.

If the classification of the second stage is determined as FALSE, the selected window is rejected. If the classification of the second stage is determined as TRUE, a classification of a next stage may be performed on the selected window.

Windows determined as TRUE in all the recursive column classifying units 131 through 13k are transmitted to the clustering and tracking unit 151.

If the selected window is rejected or if a classification of the selected window is completed, a window of different location may be selected in an integral column image. After that, a classification may be performed again on the new selected window. If a classification with respect to all the windows of the integral column image is completed, a classification may be performed in an integral column image having a different size.

As described above, if a classification is performed by column unit, various types of features may be used. By contrast, a classification using a conventional integral image has a limitation that it can use only a feature of a square shape. According to some embodiments of the inventive concept, an integral column image is generated and a feature arithmetic operation is performed by column unit of the integral column image. In any type of feature, one column has one-dimensional form having a beginning pixel and an end pixel. Thus, in any type of feature, in one column, a feature arithmetic operation may be performed simply through addition and subtraction. If the integral column image and the classification of column unit are performed, various types of features may be used and reliability of the image processing device 100 and the method of detecting a target is improved.

The caching unit 121, the downscaling unit 123, the integral column generating unit 127 and the recursive column classifying units 131 through 13k perform generation and classification of the cache, and perform the downscale and the integral column image by column unit. Thus, the image processing device 100 and the method of detecting a target in accordance with some exemplary embodiments of the inventive concept satisfy on-the-fly and provide an improved target detection speed.

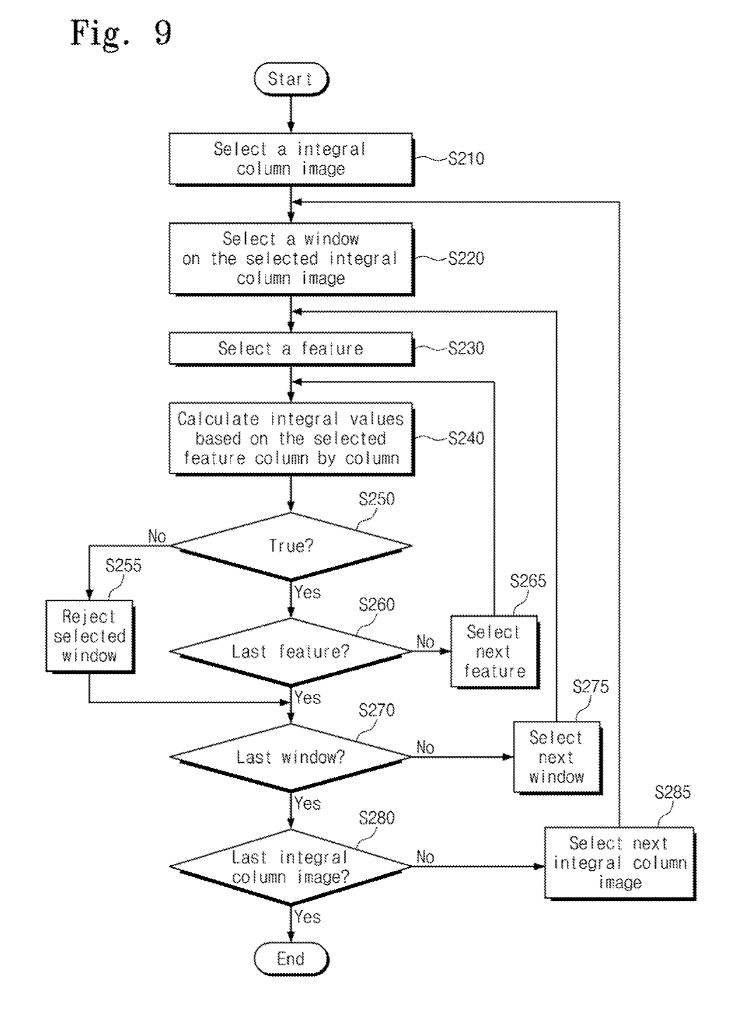

FIG. 9 is a flow chart illustrating a method of classifying an integral column image in accordance with some exemplary embodiments of the inventive concept. Referring to FIG. 9, in step S210, the first integral column image is selected among a plurality of integral column images.

In step S220, a selected window (e.g., the first window) is selected from the selected integral column image.

In step S230, a selected feature (e.g., the first feature) is selected.

In step S240, on the basis of the selected window and the selected feature, integral values are calculated by column unit (i.e., column by column).

In decision step S250, it is determined whether a calculation result is TRUE (i.e., within a range corresponding to the selected feature) or FALSE (i.e., outside of the range). If the calculation result is within a reference range corresponding to the selected feature, it is determined as TRUE and if the calculation result is not within the reference range, it is determined as FALSE. If the calculation result is FALSE, the selected window is rejected in step S255 and decision step S270 is performed. If the calculation result is TRUE, step decision S260 is performed.

In the decision step S270, it is determined whether the selected window is the last window. If the selected window is not the last window, a next window is selected (e.g., an index, not shown, is incremented) in step S275 and the step S230 is performed again with the new selected window. If the selected window is the last window, decision step S280 is performed.

In the decision step S280, it is determined whether the currently selected integral column image is the last integral column image. If the currently selected integral column image is not the last integral column image, in step S285, a next integral column image is selected (e.g., an index, not shown, is incremented) and the step S220 is performed again. If the selected integral column image is the last integral column image, a classification is completed.

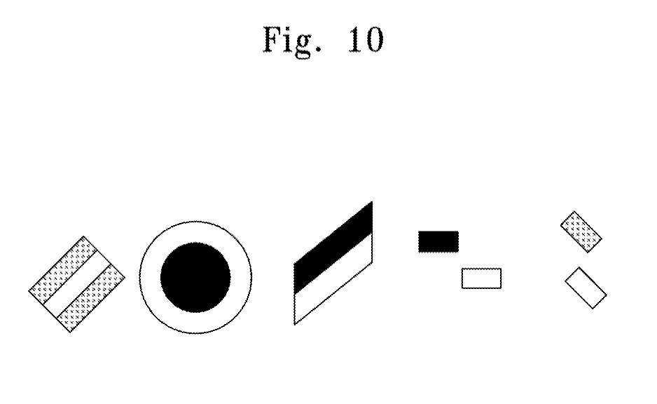

FIG. 10 is a drawing illustrating various types of features that can be applied to (and detected by) the image processing device of FIG. 2 and the method of detecting a target in accordance with some exemplary embodiments of the inventive concept. Referring to FIG. 10, the features may have a diagonal line type and a curve type. The various types of features have one-dimensional form having a beginning and an end in each column. Thus, if a classification of column unit is performed, a classification may be performed simply through sum and difference calculations.

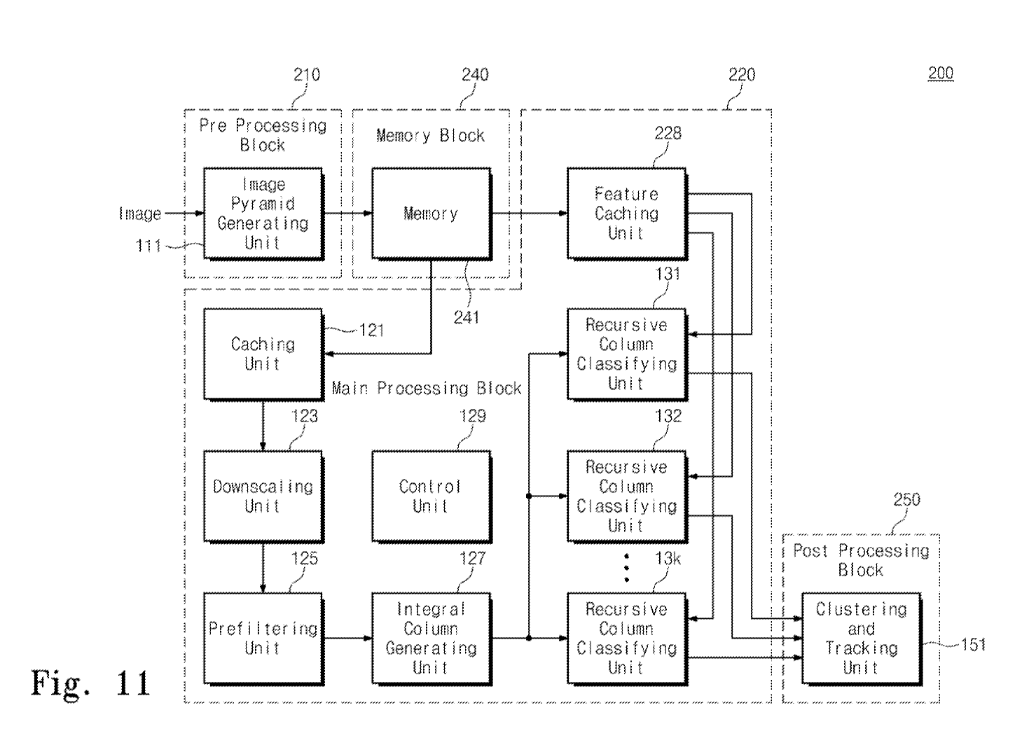

FIG. 11 is a block diagram illustrating a second example of image processing device 200 configured to perform the method of FIG. 1. Referring to FIG. 11, the image processing device 200 includes a preprocessing block 210, a main processing block 220, a memory block 240 and a post processing block 250. The preprocessing block 210 includes an image pyramid generating unit 111. The main processing block 220 includes a caching unit 121, a downscaling unit 123, a prefiltering unit 125, an integral column generating unit 127, a feature caching unit 128, a control unit 129 and a plurality of recursive column classifying units 131 through 13k. The memory block 240 includes a memory 141. The post processing block 250 includes a clustering and tracking unit 151.

When comparing the image processing device 200 with the image processing device 100 of FIG. 2, an image pyramid generated in the image pyramid generating unit 111 may be stored in the memory 141. The image pyramid stored in the memory 141 may then be transmitted to the caching unit 121.

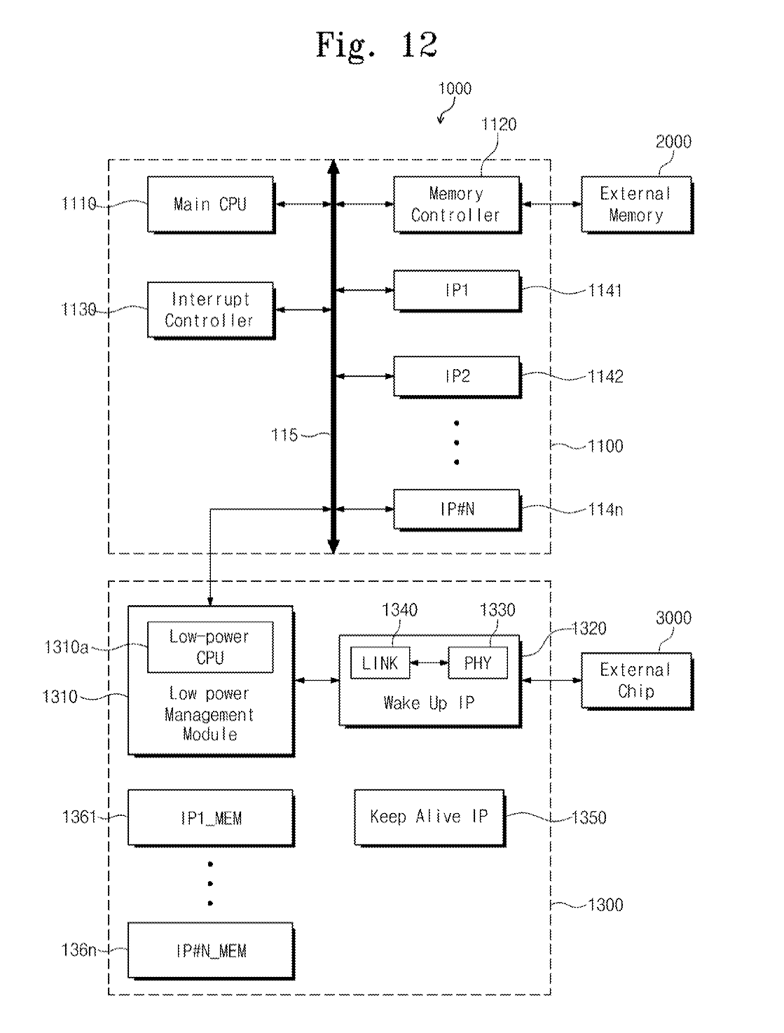

FIG. 12 is a block diagram illustrating a system-on-chip 1000, and an external memory 2000 and an external chip 3000 that communicate with the system-on-chip 1000 in accordance with some exemplary embodiments of the inventive concept. Referring to FIG. 12, the system-on-chip 1000 includes a power-OFF domain block 1100 and a power-ON domain block 1300.

The power-OFF domain block 1100 is a block that is power-downed to realize a low power of the system-on-chip 1000. The power-ON domain block 1300 is a block that becomes power-ON to operate a part of functions of the power-OFF domain block 1100 while the power-OFF domain block 1100 is in a power-down state.

The power-OFF domain block 1100 includes a main central processing unit (CPU) 1110, an interrupt controller 1130, a memory controller 1120, first through nth intellectual properties (IP) 1142 through 114n and a system bus 1150.

The main central processing unit 1110 controls the memory controller 1120 to access the external memory 2000. The memory controller 1120 transmits data stored in the external memory 2000 to the system bus 1150 in response to a control of the main central processing unit 1110.

When an interruption (i.e., a specific event) occurs in each of the first through nth intellectual properties (IP) 1142 through 114n, the interrupt controller 1130 informs the main central processing unit 1110. The first through nth intellectual properties (IP) 1142 through 114n perform specific operations according to a function of the system-on-chip 1000. The first through nth intellectual properties (IP) 1141 through 114n access internal memories IP[#]_MEM 1361 through 136n respectively. The power-ON domain block 1300 includes the internal memories IP[#]_MEM 1361 through 136n of the first through nth intellectual properties (IP) 1142 through 114n.

The power-ON domain block 1300 includes a low power management module 1310, a wake-up IP 1320, a keep alive IP 1350 and the internal memories 1361 through 136n of the first through nth intellectual properties (IP) 1142 through 114n.

The low power management module 1310 determines whether to wake-up the power-OFF domain block 1100 according to data transmitted from the wake-up IP 1320. Power of the power-OFF domain block 1100 that is turned OFF during a standby state waiting an external input may be turned OFF. The wake-up is an operation applying a power supply again when data from the outside is input to the system-on-chip 1000 that becomes power-OFF. That is, the wake-up is an operation of making the system-on-chip in a standby state become an operation state (power-on state) again.

The wake-up IP 1320 includes a PHY 1330 and a LINK 1340. The wake-up IP performs an interface role between the low power management module 1310 and the external chip 3000. The PHY 1330 actually exchanges data with the external chip 3000 and the LINK 1340 transmits and receives the data actually exchanged in the PHY 1330 to and from the low power management module 1310.

The keep alive IP 1350 determines a wake-up operation of the wake-up IP 1320 to activate or deactivate electric power of the power-OFF domain block 1100.

The low power management module 1310 receives data from at least one IP of the first through nth intellectual properties (IP) 1142 through 114n. In the case that data is only transmitted without being processed, the low power management module 1310 stores the received data in an internal memory of the corresponding IP in place of the main central processing unit 1110.

The internal memories 1361 through 136n of the first through nth intellectual properties (IP) 1141 through 114n are accessed by corresponding IPs in the power-ON mode and are accessed by the low power management module 1310 in the power-OFF mode.

At one IP among the first through nth intellectual properties (IP) 1141 through 114n can correspond to the preprocessing block 110 or 210, the main processing block 120 or 220 and the post processing block 150 or 250 of the image processing device 100 or 200 in accordance with some exemplary embodiments of the inventive concept. At least one IP can include one of the preprocessing blocks 110 or 210, the main processing block 120 or 220 and the post processing block 150 or 250. The first through nth intellectual properties (IP) 1141 through 114n may include a graphic processing unit (GPU), a modem, a sound controller, a security module, etc.

At least one internal memory of the internal memories 1361 through 136n can correspond to the memory block 140 or 240 of the image processing device 100 or 200 in accordance with some exemplary embodiments of the inventive concept.

The image processing device 100 or 200 in accordance with some exemplary embodiments of the inventive concept can form the system-on-chip 1000.

The system-on-chip 1000 can form an application processor (AP0.

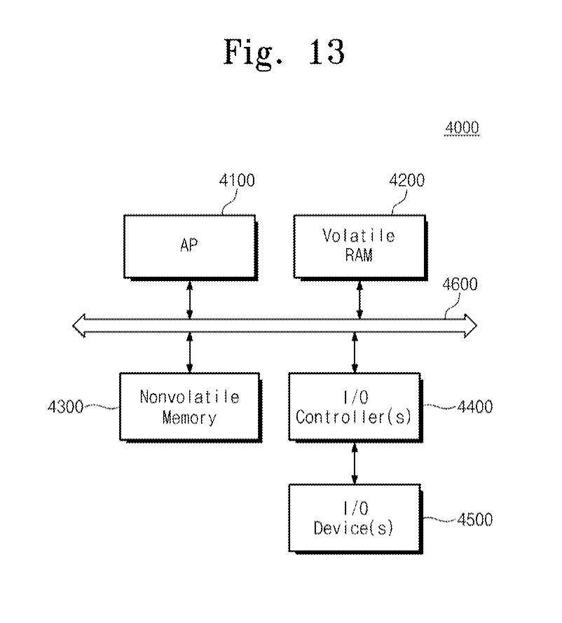

FIG. 13 is a block diagram illustrating a multimedia device 4000 in accordance with some exemplary embodiments of the inventive concept. Referring to FIG. 13, the multimedia device 4000 includes an application processor 1100, a volatile memory 4200, a nonvolatile memory 4300, one or more input/output controllers 4400, one or more input/output devices 4500 and a bus 4600.

The application processor 4100 is configured to control an overall operation of the multimedia device 4000. The application processor 4100 can be formed of one system-on-chip (SoC). The application processor 4100 may include the system-on-chip 1000 described with reference to FIG. 12. The application processor 4100 may include the image processing device 100 or 200 described with reference to FIG. 1 or 11. The application processor 4100 may further include a graphic processing unit (GPU), a sound controller, a security module, etc. The application processor 4100 may further include a modem.

The volatile memory 4200 may be an operational memory of the multimedia device 4000. The volatile memory 4200 may include a dynamic random access memory (DRAM) or a static random access memory (SRAM).

The nonvolatile memory device 4300 may be a main storage place of the multimedia device 4000. The nonvolatile memory 4300 may include a nonvolatile storage device such as a flash memory, a hard disk drive, a solid state drive, etc.

The one or more input/output controllers 4400 are configured to control the one or more input/output devices 4500.

The one or more input/output devices 4500 may include various devices receiving a signal from the outside. The one or more input/output devices 4500 may include a keyboard, a keypad, a button, a touch panel, a touch screen, a touch pad, a touch ball, a camera including an image sensor, a microphone, a gyroscope sensor, a vibration sensor, a data port for a wire input, an antenna for a wireless input, etc.

The one or more input/output devices 4500 may include various devices outputting a signal to the outside. The one or more input/output devices 4500 may include a liquid crystal display (LCD), an organic light emitting diode (OLED) display device, an active matrix OLED (AMOLED) display device, an LED, a speaker, a motor, a data port for a wire output, an antenna for a wireless output, etc.

The multimedia device 4000 obtains an image that may include a target and can perform an integral arithmetic operation of column unit (column by column) on the obtained image. The multimedia device 4000 tracks a target using various features and can track a pose, feelings and an atmosphere of the target.

The multimedia device 4000 may be implemented as a mobile multimedia device such as a smart phone, a smart pad, a digital camera, a digital camcorder, a notebook computer, etc. or a fixed multimedia device such as a smart television, a desktop computer, etc.

According to an aspect of the inventive concept, a feature arithmetic operation is performed by column unit using an integral column image. Thus, various types of features may be detected and a method of detecting a target and an image processing device having improved target detecting function and speed are provided.

The foregoing is illustrative of the inventive concept and is not to be construed as limiting thereof. Although a few exemplary embodiments of the inventive concept have been described, those skilled in the art will readily appreciate that many modifications are possible in the exemplary embodiments without materially departing from the novel teachings of the present inventive concept. Accordingly, all such modifications are intended to be included within the scope of the present invention as defined in the claims. The present invention is defined by the following claims, with equivalents of the claims to be included therein.

What is claimed is:

1. A method of detecting a target in an image comprising:
receiving the image;
generating a plurality of down-scaled images based on the received image;
generating integral column images of each of the plurality of down-scaled images by calculating integral values of the pixels in each column therein;
selecting a plurality of portions of the integral column images;
detecting the target on the basis of classifying each selected portion according to a feature-detecting arithmetic operation based on recursive column calculations using the integral values of the pixels in each column.

2. The method of claim 1, wherein generating the plurality of down-scaled images comprises:
generating an image pyramid based on the received image; and
generating intermediate images by down-scaling each image of the image pyramid.

3. The method of claim 2, wherein generating the intermediate images is performed column by column for each image of the image pyramid.

4. The method of claim 1, wherein generating the integral column images comprises calculating integral values of pixels along a specific direction in each column and generating an integral column image having calculated integral values.

5. The method of claim 4, wherein the values of the pixels are gray scale values.

6. The method of claim 1, wherein detecting the target comprises:
selecting one integral column image among the integral column images;
selecting a window from the selected integral column image as the currently selected portion;
selecting a first feature and designating a selected area and an unselected area of the currently selected window;
calculating the sum of pixel values in the selected area by calculating column by column the difference between integral values along the upper and lower boundary of the selected area and
calculating the sum of pixel values in the unselected area by calculating column by column the difference between integral values along the upper and lower boundary of the unselected area; and
classifying the window by deeming classification result as TRUE if the sum of the pixel values in the selected area is within a reference range and by deeming classification result as FALSE if the sum of the pixel values in the select area is not within the reference range.

7. The method of claim 6, wherein if the selected window is classified as FALSE, the selected window is rejected and the detection of the target is discontinued in the selected window.

8. The method of claim 6, wherein classifying the widow further comprises selecting a second feature having a second selected area and a second unselected area different from that of the first feature if the selected window is classified as TRUE, calculating the sum of pixel values in the second selected area of the second feature and classifying a classification result for the second feature as TRUE or FALSE according to the comparison result of the sum of pixel values corresponding to the second feature and the reference range.

9. The method of claim 6, wherein if a classification of the first selected window in the selected integral column is completed, a second window in the selected integral column at a different location than the location of the first selected window image is selected, and classifying the second selected window as TRUE or FALSE is performed again with respect to each of the first and second features.

10. The method of claim 6, wherein if a classification of the first selected window is completed, detecting the target is performed on the basis of other windows among windows of the selected integral column image are likewise classified as TRUE or FALSE.

11. The method of claim 6, further comprising: if the classification result of all windows of the selected integral column image is FALSE, selecting a second integral column image, and selecting a window therein, selecting the first feature, calculating the sum of pixel values in a select area of the window and classifying the classification result of the window as TRUE or FALSE.

12. An image processing device comprising:
an image pyramid generating unit for receiving an image and generating an image pyramid based on the received image;
a downscaling unit receiving the image pyramid and down-scaling each image of the image pyramid to output a plurality of scaled images including the image pyramid and the downscaled image;
a prefiltering unit outputting part of the plurality of the images on the basis of color maps of the plurality of images;
an integral column generating unit receiving the part of the plurality of the images and configured to generate an integral column image from each by calculating integrals of the pixels of the images column by column;
a plurality of recursive column classifying units receiving the integral column images and classifying each window of each of the integral column images according to a feature arithmetic operation based on a recursive column calculation; and
a clustering unit for detecting a target in the image according to the classification results of windows.

13. The image processing device of claim 12, wherein the integral column generating unit generates the integral column images by replacing pixel values of each column of each of the part of the plurality of images with integral values of the pixel values along a specific direction respectively.

14. The image processing device of claim 13, wherein each of the plurality of recursive column classifying units selects a window from the received integral column image, selects different features from each other and designates a selected area and an unselected area of the selected window, calculates the sum of pixel values in the selected area by calculating the difference between the integral values at the upper and lower boundary of the selected area, classifies a classification result of the window as TRUE if the sum of the pixel values in the selected area is within a reference range and classifies a classification result of the window as FALSE if the sum of the pixel values in the selected area is not within the reference range.

15. The image processing device of claim 14, wherein the plurality of recursive column classifying units operate in cascade manner and a specific recursive column classifying unit receives a window classified as TRUE with respect to a first feature in a recursive column classifying unit of a previous stage to classify the window TRUE or FALSE with respect to a second feature.

16. An apparatus comprising:
an image pyramid generating unit for receiving an image and configured to generate a plurality of down-scaled images based on the received image;
an integral column generating unit receiving each one of the plurality of the down-scaled images and configured to generate an integral column image from each down-scaled image by calculating an integrals of the pixels therein column by column.

17. The image processing device of claim 16, further comprising
a plurality of recursive column classifying units receiving the integral column images and classifying each window in each of the integral column images according to a feature arithmetic operation based on a recursive column calculation.

18. The image processing device of claim 17, further comprising: a clustering unit for detecting a target in the image according to the classification results of the windows.
